(19) United States
(12) Patent Application Publication
(10) Pub. No.: US 2004/0005994 A1
(43) Pub. Date: Jan. 8, 2004

(54) Solid compositions containing hydrocolloids and processes for preparing the same

(76) Inventors: Rainer Eskuchen, Langenfeld (DE); Franz Wenin, Korschenbroich (DE)

Correspondence Address: COGNIS CORPORATION, PATENT DEPARTMENT, 300 BROOKSIDE AVENUE, AMBLER, PA, 19002, US

(21) Appl. No.: 10/402,424

(22) Filed: Mar. 28, 2003

(30) Foreign Application Priority Data
Mar. 30, 2002 (DE) 102 14 388.9

(51) Int. Cl. C11D 17/00; C11D 17/06

(52) U.S. Cl. 510/445; 510/446; 510/447; 510/452

(57) ABSTRACT

Solid mixtures comprising: (a) a solid carrier, (b) a surfactant component, (c) a component which is liquid at room temperature, and (d) a hydrocolloid are described along with processes for their production and their use.

### BACKGROUND OF THE INVENTION

In the production of solid supply forms of detergents for example, problems arise when, in addition to the solid constituents, substances liquid at room temperature (21° C.) are also to be processed and particularly when these liquid components are to be used in relatively high concentrations.

The problem addressed by the present invention was to provide solid supply forms which would have relatively high percentage contents of constituents liquid at room temperature but which, nevertheless, would be free-flowing and non-tacky.

### SUMMARY OF THE INVENTION

It has now been found that the problem stated above can be solved by the addition of the liquid components in combination with so-called hydrocolloids. This invention relates to mixtures of solids which contain at least one liquid or gelling component, to a process for the production of the mixtures and to their use.

In a first embodiment, the present invention relates to mixtures of solids which contain at least a) a solid carrier, b) a surfactant constituent, c) a constituent liquid at room temperature, d) a hydrocolloid and e) optionally auxiliaries and additives.

The solid carrier a) used is, in particular, finely crystalline, synthetic zeolite containing bound water, such as detergent-quality zeolite NaA. However, zeolite NaX and mixtures of NaA and NaX also suitable. The zeolite may be used in the form of a spray-dried powder or even in the form of an undried stabilized suspension still moist from its production. Where the zeolite is used in the form of a suspension, the suspension may contain small additions of nonionic surfactants as stabilizers, for example 1 to 3% by weight, based on zeolite, of ethoxylated C₁₂₋₁₈ fatty alcohols containing 2 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water. Suitable substitutes or partial substitutes for zeolites are crystalline layer-form sodium silicates corresponding to the general formula NaMSiₓO₂ₓ₊₁.yH₂O, where M is sodium or hydrogen, x is a number of 1.9 to 4 and y is a number of 0 to 20, preferred values for x being 2, 3 or 4. Preferred crystalline layer silicates corresponding to the above formula are those in which M is sodium and x assumes the value 2 or 3. Both β- and δ-sodium disilicates Na₂Si₂O₅.yH₂O are particularly preferred. The compositions according to the invention preferably contain 10 to 60% by weight of zeolite and/or crystalline layer silicates as solid component a). Mixtures of zeolite and crystalline layer silicates in any ratio can be particularly advantageous. In a particularly preferred embodiment, the compositions contain 20 to 50% by weight zeolite and/or crystalline layer silicates. Particularly preferred compositions contain up to 40% by weight zeolite and more particularly up to 35% by weight zeolite, based on water-free active substance.

Other suitable ingredients a) are water-soluble amorphous silicates which are preferably used in combination with zeolite and/or crystalline layer silicates. Particularly preferred compositions contain, above all, sodium silicate with a molar ratio (modulus) Na₂O:SiO₂ of 1:1 to 1:4.5 and preferably 1:2 to 1:3.5. The compositions have an amorphous sodium silicate content of preferably up to 15% by weight and more preferably between 2 and 8% by weight. Small quantities of phosphates, such as tripolyphosphates, pyrophosphates and orthophosphates, may also be present in the compositions. The compositions preferably have a phosphate content of up to 15% by weight and more particularly between 0 and 10% by weight. In addition, the compositions may also contain layered silicates of natural and synthetic origin. However, smectites, more especially bentonites, are preferred for the purposes of the invention. Suitable layered silicates which belong to the group of water-swellable smectites are, for example, those corresponding to the following general formulae:

(OH)₄Si_{8-y}Al_{y}(MgₓAl₄₋ₓ)O₂₀ montmorillonite

(OH)₄Si_{8-y}Al_{y}(Mg_{6-z}Li_{z})O₂₀ hectorite

(OH)₄Si_{8-y}Al_{y}(Mg_{6-z}Al_{z})O₂₀ saponite

where x=0 to 4, y=0 to 2 and z=0 to 6. Small amounts of iron may additionally be incorporated in the crystal lattice of the layer silicates corresponding to the above formulae. In addition, by virtue of their ion-exchanging properties, the layered silicates may contain hydrogen, alkali metal and alkaline-earth metal ions, more particularly Na⁺ and Ca²⁺. The quantity of water of hydration is generally in the range from 8 to 20% by weight and is dependent upon the degree of swelling or upon the treatment method. Layered silicates which, by virtue of an alkali treatment, are largely free from calcium ions and strongly coloring iron ions are preferably used.

Useful organic builders are, for example, the polycarboxylic acids preferably used in the form of their sodium salts, such as citric acid, adipic acidic acid, succinic acid, glutaric acid, tartaric acid, sugar acids, aminocarboxylic acids, nitrilotriacetic acid (NTA), providing their use is not ecologically unsafe, and mixtures thereof. Preferred salts are the salts of polycarboxylic acids, such as citric acid, adipic acid, succinic acid, glutaric acid, tartaric acid, sugar acids and mixtures thereof. Suitable polymeric polycarboxylates are, for example, the sodium salts of polyacrylic acid or polymethacrylic acid, for example those with a relative molecular weight of 800 to 150,000 (based on acid). Suitable copolymeric polycarboxylates are, in particular, those of acrylic acid with methacrylic acid and acrylic acid or methacrylic acid with maleic acid. Copolymers of acrylic acid with maleic acid which contain 50 to 90% by weight of acrylic acid and 50 to 10% by weight of maleic acid are particularly suitable. Their relative molecular weight, based on free acids, is generally in the range from 5,000 to 200,000, preferably in the range from 10,000 to 120,000 and more preferably in the range from 50,000 to 100,000. It is not absolutely essential to use polymeric polycarboxylates. However, if polymeric polycarboxylates are used, compositions containing biodegradable polymers, for example terpolymers which contain acrylic acid and maleic acid or salts thereof and vinyl alcohol or vinyl alcohol derivatives as monomers or acrylic acid and 2-alkyl allyl sulfonic acid or salts thereof and sugar derivatives as monomers are preferred. Other suitable builders are polyacetals which may be obtained by reacting dialdehydes with polyol carboxylic acids containing 5 to 7 carbon atoms and at least 3 hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Other suitable solids a) are urea and solid derivatives thereof, pyrophosphates, sucrose, dextrose, cyclodextrins, glucose syrup, sorbitol, aldehydes, amines, organic and inorganic Sa salts.

Generally speaking, suitable components a) should have a structure which enables them to absorb or bind component c). It is particularly preferred to use waterglasses and zeolites or sucrose.

In a particularly preferred embodiment, mixtures of component a) are used. For example, waterglass is preferably used together with sucrose as component a), quantity ratios of sucrose to waterglass of 3:1 to 1:1 being preferred.

The compositions according to the invention additionally contain a surfactant constituent selected from anionic, nonionic and/or amphoteric surfactants as component b). Surfactants solid at room temperature are preferably used as component b).

Suitable anionic surfactants are, for example, alkyl benzenesulfonates preferably corresponding to formula (I):

R′—Ph—SO₃X (I)

in which R′ is a branched, but preferably linear alkyl group containing 10 to 18 carbon atoms, Ph is a phenyl group and X is an alkali metal and/or alkaline earth metal, ammonium, alkylammonium, alkanolammonium or glucammonium. Of these alkyl benzenesulfonates, dodecyl benzenesulfonates, tetradecyl benzenesulfonates, hexadecyl benzenesulfonates and technical mixtures thereof in the form of the sodium salts are particularly suitable.

Alkyl and/or alkenyl sulfates, which are also often referred to as fatty alcohol sulfates, are understood to be the sulfation products of primary and/or secondary alcohols which preferably correspond to formula (II):

R″O—SO₃X (II)

in which R″ is a linear or branched, aliphatic alkyl and/or alkenyl group containing 6 to 22 and preferably 12 to 18 carbon atoms and X is an alkali metal and/or alkaline earth metal, ammonium, alkylammonium, alkanolammonium or glucammonium. Typical examples of alkyl sulfates which may be used in accordance with the invention are the sulfation products of caproic alcohol, caprylic alcohol, capric alcohol, 2-ethylhexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxosynthesis. The sulfation products may advantageously be used in the form of their alkali metal salts, more especially their sodium salts. Alkyl sulfates based on C_{16/18} tallow fatty alcohols or vegetable fatty alcohols with a comparable C-chain distribution in the form of their sodium salts are particularly preferred.

Alkyl ether sulfates (“ether sulfates”) are known anionic surfactants which are industrially produced by the sulfation of fatty alcohol or oxoalcohol polyglycol ethers with SO₃ or chlorosulfonic acid (CSA) and subsequent neutralization. Ether sulfates suitable for the purposes of the invention correspond to formula (III):

R′″O—(CH₂CH₂O)ₘSO₃X (III)

in which R′″ is a linear or branched alkyl and/or alkenyl group containing 6 to 22 carbon atoms, m is a number of 1 to 10 and X is an alkali metal and/or alkaline earth metal, ammonium, alkylammonium, alkanolammonium or glucammonium. Typical examples are the sulfates of addition products of on average 1 to 10 and, more particularly, 2 to 5 mol of ethylene oxide onto caproic alcohol, caprylic alcohol, 2-ethyl hexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and technical mixtures thereof in the form of their sodium and/or magnesium salts. The ether sulfates may have both a conventional homolog distribution and a narrow homolog distribution. It is particularly preferred to use ether sulfates based on adducts of, on average, 2 to 3 mol of ethylene oxide with technical C_{12/14} or C_{12/18} coconut fatty alcohol fractions in the form of their sodium and/or magnesium salts.

Acyl glutamates are known anionic surfactants corresponding to formula (V):

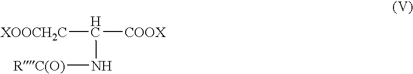

in which R″″ CO is a linear or branched acyl group containing 6 to 22 carbon atoms and 0 and/or 1, 2 or 3 double bonds and X is hydrogen, an alkali metal and/or alkaline earth metal, ammonium, alkylammonium, alkanolammonium or glucammonium. They are produced, for example, by Schotten-Baumann acylation of glutamic acid with fatty acids, fatty acid esters or chlorides. Corresponding commercial products are available, for example, from Hoechst AG, Frankfurt, FRG or from the Ajinomoto Co. Inc., Tokyo, JP. Typical examples of suitable acyl glutamates suitable for the purposes of the invention are anionic surfactants derived from fatty acids containing 6 to 22 and preferably 12 to 18 carbon atoms, for example C_{12/14} or C_{12/18} cocofatty acid, lauric acid, myristic acid, palmitic acid and/or stearic acid. Sodium-N-cocoyl and sodium N-stearoyl-L-glutamate are particularly preferred.

Suitable nonionic surfactants are alcohol ethoxylates. Alcohol ethoxylates are known as fatty alcohol or oxoalcohol ethoxylates from their production and preferably correspond to formula (VI):

R′″″O(CH₂CH₂O)ₙH (VI)

in which R′″″ stands for a linear or branched alkyl and/or alkenyl group containing 6 to 22 carbon atoms and n is a number of 1 to 50. Typical example are the addition products of on average 1 to 50, preferably 5 to 40 and more particularly 10 to 25 mol ethylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxo synthesis and as monomer fraction in the dimerization of unsaturated fatty alcohols. Addition products of 10 to 40 mol ethylene oxide onto technical fatty alcohols containing 12 to 18 carbon atoms such as, for example, coconut oil, palm oil, palm kernel oil or tallow fatty alcohol are preferred.

Betaines are known surfactants which are mainly produced by carboxyalkylation, preferably carboxymethylation, of aminic compounds. The starting materials are preferably condensed with halocarboxylic acids or salts thereof, more particularly with sodium chloroacetate, 1 mol of salt being formed per mol of betaine. The addition of unsaturated carboxylic acids, for example acrylic acid, is also possible. Examples of suitable betaines are the carboxyalkylation products of secondary and, in particular, tertiary amines corresponding to formula (VII):

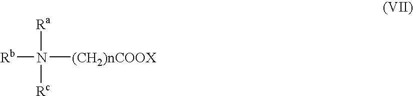

in which R^{b} stands for alkyl and/or alkenyl groups containing 6 to 22 carbon atoms, R^{a} stands for hydrogen or alkyl groups containing 1 to 4 carbon atoms, R^{c} stands for alkyl groups containing 1 to 4 carbon atoms, n is a number of 1 to 6 and X is an alkali metal and/or alkaline earth metal or ammonium. Typical examples are the carboxymethylation products of hexyl methyl amine, hexyl dimethyl amine, octyl dimethyl amine, decyl dimethyl amine, dodecyl methyl amine, dodecyl dimethyl amine, dodecyl ethyl methyl amine, C_{12/14} cocoalkyl dimethyl amine, myristyl dimethyl amine, cetyl dimethyl amine, stearyl dimethyl amine, stearyl ethyl methyl amine, oleyl dimethyl amine, C_{16/18} tallow alkyl dimethyl amine and technical mixtures thereof.

Other preferred surfactants are alkyl oligoglycosides with the formula R¹O-[G]ₚ in which R¹ is an alkyl and/or alkenyl group containing 4 to 22 carbon atoms, G is a sugar unit containing 5 or 6 carbon atoms and p is a number of 1 to 10. Preferred compositions according to the invention contain alkyl oligoglycosides with the above formula as surfactant component b).

The presence of substances c) liquid at room temperature in the compositions is essential to the invention. The substances in question are preferably fats and oils liquid at room temperature (21° C.) and liquid nonionic surfactants. Soya oil is particularly preferred as component c). Soya oil is a yellowish to brown-yellow, fatty, semidrying oil obtained from soya beans (Glycine max) or soya bran by pressing and/or extraction with hydrocarbons (for example hexane). Oil content of soya beans: 17-22%. 55 to 65% of the total fatty acids of soya oil are polyunsaturated fatty acids. The sterol content of soya oil is on average 0.37% (of which 0.3 to 0.5% is cholesterol). Besides cholesterol, soya oil contains above all ergost-5-en-3b-ol, campesterol and sitosterol. The sterol content can be reduced by ca. 30% by refining. In addition, soya oil contains free fatty acids, lecithin and up to 0.8% tocopherol. Like most oils that are processed for nutritional purposes, soya oil passes through the individual steps of refining among which “delecithinizing” (enrichment of the phospholipids after addition of water at the boundary layer and separation in separators) is particularly important for the production of soya lecithin. Analysis: density 0.916-0.922, melting point −15 to −8° C., solidus point 282° C., saponification value 188-195, iodine value 120-136, acid value 0.3-3.0, unsaponifiables 0.5-1.5%. Besides soya oil, other oils liquid at room temperature, particularly perfume oils, may also be used.

Hydrocolloids d) are used either at the same time or at a different time, preferably being selected from the group consisting of gelatin, alginates, pectins, modified starch, carrageenans, agar, xanthan, galactomannans, gum arabic. These compounds undergo an increase in viscosity in water and, accordingly, are also used as thickeners.

Component a) is present in quantities of 1 to 90% by weight, preferably in quantities of 5 to 90% by weight, more preferably in quantities of 5 to 75% by weight and most preferably in quantities of 20 to 65% by weight, based on the solid composition. The surfactant component b) is present in the compositions in quantities of preferably 1 to 60% by weight, more preferably 10 to 55% by weight and most preferably 15 to 45% by weight. Components c) and d) are present in total quantities of preferably 2 to 65% by weight, more preferably 5 to 50% by weight, most preferably 5 to 40% by weight and, in a most particularly preferred embodiment, 10 to 35% by weight. It can be of advantage to establish a ratio by weight of component c) to component d) of 3:1 to 1:1. Component c) is preferably used in excess in relation to component d).

If other auxiliaries and additives are present, they are present in quantities of typically 1 to 15% by weight, preferably 1 to 10% by weight and more preferably 1 to 5% by weight. The compositions also contain water after drying, albeit in small quantities. The exact water content depends on the particular drying method used. Typical water contents are below 10% by weight, preferably below 5% by weight and more particularly below 3% by weight.

The present invention also relates to a process for the production of mixtures of solids as described in the foregoing. The process according to the invention is characterized in that an aqueous emulsion is initially prepared from components a) to d) and optionally e) and the emulsion thus prepared is subsequently dried at elevated temperature. Drying may be carried out by any of the methods familiar to the expert, more particularly by spray drying or by using a fluidized bed granulation dryer. Accordingly, the compositions according to the invention may be present as powders or—preferably—as granules.

### EXAMPLE

The production of the mixtures according to the invention is described in the following. First, water is heated to 75° C. and component d) and component a) are then added in that order. Component b) and component c) are then added. In Examples 1 to 7, the emulsion was then dried at 75° C. in a vacuum drying cabinet. In Example 10 by contrast, the emulsion was introduced into a fluidized bed granulation dryer (Glatt AGT 150) at 700 g/h and sprayed through a two-component nozzle. After the emulsion, 160 g/h of a mixture of urea, potassium pyrophosphate and waterglass were introduced into the dryer via a metering screw for solids. Drying was carried out at a fluidized bed temperature of 75° C. and an air temperature of 115° C. A free-flowing non-tacky solid was obtained in every case.

The compositions (in % by weight) of the aqueous emulsions are set out in Table 1.

TABLE 1

| | 1 | 2 | 3 | 4 | 5 | 6 | 7 | 8 | 9 | 10 |
|---|---|---|---|---|---|---|---|---|---|---|
| Soya oil | 14.3 | | | | | | | | | |
| Soya lecithin | | 14.3 | | 14.3 | 14.3 | 14.3 | | | | 11.7 |
| C₁₂₋₁₈ fatty | | | 13 | | | | 15 | | | |
| alcohol + 7 EO | | | | | | | | | | |
| Perfume oil | | | | | | | | 1.1 | 1.3 | |
| Gelatin | 24 | 24 | | | | | | | | 19.5 |
| τ-Carrageenan | | | | 3 | | | | | | |
| κ-Carrageenan | | | 1.5 | | 3 | | 1.5 | 1.9 | 1.9 | |
| Xanthan | | | | | | 5 | | | | |
| Sucrose | 8.8 | 8.8 | 14 | 8.8 | 8.8 | 8.8 | 14 | 7.7 | 19.4 | 7.2 |
| C₁₂₋₁₄ alkyl | 2 | 2 | 2 | 2 | 2 | 2 | 2 | 1.6 | 1.6 | 1.6 |
| polyglucoside | | | | | | | | | | |
| Urea | 11.6 | | | | | | | | | |
| Waterglass | 2.9 | | | | | | | | | |
| Potassium | | | | | | | | | | 4.1 |
| pyrophosphate | | | | | | | | | | |
| Starch | | | | | | | 2.4 | | | |
| Cyclodextrin | | | | | | | | 15.3 | | |
| Water | Rest | Rest | Rest | Rest | Rest | Rest | Rest | Rest | Rest | Rest |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A solid mixture comprising: (a) a solid carrier, (b) a surfactant component, (c) a component which is liquid at room temperature, and (d) a hydrocolloid.

2. The mixture according to claim 1, wherein the solid carrier comprises a substance selected from the group consisting of zeolites, waterglasses, solid polycarboxylic acids and polycarboxylates, sucrose, dextrose, cyclodextrins, glucose syrup, sorbitol, aldehydes, amines, calcium salts, urea and pyrophosphates.

3. The mixture according to claim 1, wherein the solid carrier comprises a substance selected from the group consisting of zeolites, waterglasses, and sucrose.

4. The mixture according to claim 1, wherein the solid carrier comprises a mixture of sucrose and a waterglass.

5. The mixture according to claim 1, wherein the surfactant component comprises a surface-active agent selected from the group consisting of anionic surfactants, nonionic surfactants, amphoteric surfactants and mixtures thereof.

6. The mixture according to claim 1, wherein the surfactant component comprises an alkyl oligoglycoside of the general formula R¹O-[G]ₚ, wherein R¹ represents an alkyl and/or alkenyl group having from 4 to 22 carbon atoms, G represents a sugar unit having 5 or 6 carbon atoms and p represents a number of from 1 to 10.

7. The mixture according to claim 1, wherein the component which is liquid at room temperature is selected from the group consisting of lecithins, fats and oils liquid at room temperature, perfume oils, and liquid nonionic surfactants.

8. The mixture according to claim 1, wherein the hydrocolloid comprises a compound selected from the group consisting of gelatin, alginates, pectins, modified starch, carrageenans, agar, xanthan, galactomannans, and gum arabic.

9. The mixture according to claim 1, wherein the hydrocolloid comprises a compound selected from the group consisting of gelatin, carrageenans, and xanthan.

10. The mixture according to claim 1, wherein the solid carrier is present in an amount of from 1 to 90% by weight.

11. The mixture according to claim 1, wherein the solid carrier is present in an amount of from 5 to 75% by weight.

12. The mixture according to claim 1, wherein the surfactant component is present in an amount of from 1 to 60% by weight.

13. The mixture according to claim 1, wherein the surfactant component is present in an amount of from 10 to 55% by weight.

14. The mixture according to claim 1, wherein the component which is liquid at room temperature and the hydrocolloid are present in a combined amount of from 2 to 65% by weight.

15. The mixture according to claim 1, wherein the component which is liquid at room temperature and the hydrocolloid are present in a combined amount of from 5 to 50% by weight.

16. The mixture according to claim 1, wherein the component which is liquid at room temperature and the hydrocolloid are present in a ratio by weight of from 3:1 to 1:1.

17. The mixture according to claim 14, wherein the component which is liquid at room temperature and the hydrocolloid are present in a ratio by weight of from 3:1 to 1:1.

18. The mixture according to claim 1, further comprising one or more additional components selected from the group consisting of additives and auxiliaries.

19. The mixture according to claim 10, wherein the one or more additional components are present in a total amount of from 1 to 15% by weight.

20. The mixture according to claim 1, wherein the mixture is in a granulated form.

21. A solid mixture comprising: (a) a solid carrier selected from the group consisting of zeolites, waterglasses, and sucrose, (b) a surfactant component comprising an alkyl oligoglycoside of the general formula R¹O-[G]ₚ, wherein R¹ represents an alkyl and/or alkenyl group having from 4 to 22 carbon atoms, G represents a sugar unit having 5 or 6 carbon atoms and p represents a number of from 1 to 10, (c) a component which is liquid at room temperature, and (d) a hydrocolloid selected from the group consisting of gelatin, alginates, pectins, modified starch, carrageenans, agar, xanthan, galactomannans, and gum arabic; wherein the solid carrier is present in an amount of from 5 to 75% by weight, wherein the surfactant component is present in an amount of from 10 to 55% by weight, wherein the component which is liquid at room temperature and the hydrocolloid are present in a combined amount of from 5 to 50% by weight, and wherein the component which is liquid at room temperature and the hydrocolloid are present in a ratio by weight of from 3:1 to 1:1.

22. A process for producing solid mixtures, said process comprising: (i) preparing an aqueous emulsion comprising (a) a solid carrier, (b) a surfactant component, (c) a component which is liquid at room temperature, and (d) a hydrocolloid; and (ii) drying the aqueous emulsion at an elevated temperature.

23. The process according to claim 22, wherein the aqueous emulsion is dried in a fluidized bed granulation dryer.

24. The process according to claim 22, wherein the aqueous emulsion is dried by spray drying.
